(19) United States
(12) Patent Application Publication
(10) Pub. No.: US 2006/0162835 A1
(43) Pub. Date: Jul. 27, 2006

(54) Tire wheel assembly

(75) Inventors: Akira Kuramori, Hiratsuka-shi (JP); Mitsuru Naito, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO. LTD., Minato-ku, Tokyo 105-8685 (JP)

(21) Appl. No.: 10/531,374

(22) PCT Filed: Aug. 20, 2003
(86) PCT No.: PCT/JP03/10501

§ 371 Date: Apr. 15, 2005

(30) Foreign Application Priority Data
Nov. 18, 2002 (JP) 2002-333702

(51) Int. Cl. B60C 5/16

(52) U.S. Cl. 152/400

(57) ABSTRACT

A tire wheel assembly capable of enhancing the durability in run-flat driving. In the tire wheel assembly, a pneumatic tire is fitted to the rim of a wheel, and a run-flat support composed of an annular shell having a support surface projecting to the outer circumferential side and leg parts extending along both sides of the support surface, and a pair of left and right elastic rings for supporting the leg parts of the annular shell on the rim is inserted into the cavity section of the pneumatic tire. With regard to the tire wheel assembly, a relation (W2−W1)/W1=0.015-0.100 is satisfied assuming that W1 is the interval between abutting points where the pair of left and right elastic rings abut on the inner surface of the tire when the pneumatic tire and the run-flat support are mounted on the rim, and W2 is the interval between the abutting points when the run-flat support is not mounted.

### TECHNICAL FIELD

The present invention relates to a tire wheel assembly enabling run-flat driving, and more specifically, relates to a tire wheel assembly having enhanced durability in run-flat driving.

### BACKGROUND ART

Many technologies enabling emergency driving to a certain extent even when a pneumatic tire goes flat while a vehicle is running have been proposed to meet demands from the market. These many proposals include a proposal enabling run-flat driving by supporting the punctured tire with a core which is attached on a rim inside a cavity section of the pneumatic tire mounted on the rim (for example, see the Japanese Patent Laid-Open Publication No. 10(1998)-297226 and Publication of a Translation of an International Application No. 2001-519279).

The aforementioned run-flat core has a structure in which an annular shell has an open leg structure which includes a support surface projecting to an outer circumferential side and leg parts extending along both sides of the support surface. The run-flat core further includes elastic rings attached to these leg parts and is supported on a rim by way of the elastic rings. This run-flat core can be used as it is without adding any special modification to existing wheels or rims and has an advantage of being acceptable without causing any confusion in the market.

However, the tire wheel assembly including the aforementioned run-flat core has a problem that sufficient durability in run-flat driving cannot be obtained if the elastic rings for supporting the annular shell are not firmly seated in places where the elastic rings abut on the inner surface of the tire at the time of mounting. In particular, since the mounting operation is performed while the core is inserted into a cavity section of the pneumatic tire, it is difficult to surely seat the elastic rings of the core. Moreover, it is difficult in the present circumstances to check the seating state.

### DISCLOSURE OF THE INVENTION

An object of the present invention is to provide a tire wheel assembly capable of enhancing the durability in run-flat driving.

A tire wheel assembly of the present invention to achieve the aforementioned object is characterized in that: in a tire assembly, a pneumatic tire is fitted to a rim of a wheel and a run-flat support is inserted in a cavity section of the pneumatic tire; the run-flat support includes an annular shell and a pair of left and right elastic rings; the annular shell includes a support surface projecting to the outer circumferential side and leg parts extending along both sides of the support surface; the elastic rings support the leg parts of the annular shell on the rim; and with regard to the tire wheel assembly, a relation (W2−W1)/W1=0.015-0.100 is satisfied. Herein, W1 indicates an interval between abutting points where the pair of left and right elastic rings abut on the inner surface of the tire when the pneumatic tire and the run-flat support are mounted on the rim, and W2 indicates an interval between the abutting points when the run-flat support is not mounted.

In the present invention, the run-flat support is formed so that an outer diameter thereof is smaller than an inner diameter of a tread portion of the pneumatic tire so as to keep a certain distance between the pneumatic tire and the run-flat support, and the inner diameter is formed to be substantially the same as an inner diameter of the bead portion of the pneumatic tire. While being inserted in the cavity section of the pneumatic tire, this run-flat support is mounted on the rim of the wheel together with the pneumatic tire to form the tire assembly wheel. When the tire wheel assembly is attached to a vehicle and the pneumatic tire goes flat while the vehicle is running, the punctured and flat tire is supported by the support surface of the annular shell of the run-flat support, thus enabling run-flat driving.

According to the present invention, the interval W2 between the abutting points of the elastic rings before the run-flat support is mounted on the rim is set to be larger than the interval W1 between the abutting points of the elastic rings when the run-flat support is mounted on the rim at a predetermined ratio. Accordingly, the elastic rings for supporting the annular shell can be firmly seated in the places where the elastic rings abut on the inner surface of the tire at the time of mounting, thus enhancing the durability in run-flat driving.

According to the present invention, preferably, a JIS-A hardness of the elastic rings is 50 to 65. The annular shell is preferably made of metal with a yield strength of 400 MPa or more. This can prevent the annular shell from being plastically deformed at the time of mounting even when the interval W2 between the abutting points of the elastic rings before mounting is set larger.

### BRIEF DESCRIPTION OF THE DRAWINGS

FIG. 1 is a meridian cross-sectional view showing a main portion of a tire wheel assembly according to an embodiment of the present invention.

FIG. 2 is a meridian cross-sectional view showing a run-flat support of the present invention which is not mounted on a rim.

### BEST MODE FOR CARRYING OUT THE INVENTION

Hereinafter, the present invention is specifically described with reference to the accompanying drawings.

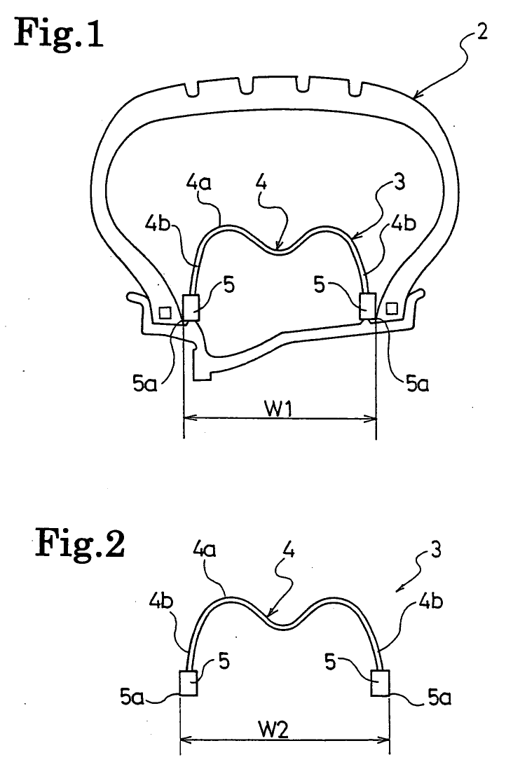

FIG. 1 is a meridian cross-sectional view showing a main portion of a tire wheel assembly (wheel) according to an embodiment of the present invention. Reference numerals 1, 2, and 3 denote a rim of the wheel, a pneumatic tire, and a run-flat support, respectively. These rim 1, pneumatic tire 2, and run-flat support 3 are formed in annular shapes coaxially around a not-shown wheel rotation axis.

The run-flat support 3 includes an annular shell 4 and elastic rings 5 as main components. This run-flat support 3 is spaced from the surface of the inner wall of the pneumatic tire 2 during normal travel. When the pneumatic tire 2 goes flat, the run-flat support 3 supports the flat pneumatic tire 2 on the inside thereof.

The annular shell 4 has an open-leg structure which includes a continuous support surface 4a projecting to the outer circumferential side (radially outward) to support the punctured tire and includes leg parts 4b and 4b extending along both sides of the support surface 4a. The support surface 4a of the annular shell 4 is formed so that the shape in a cross-section orthogonal to the circumferential direction is a curve convex surface projecting to the outer circumferential side. At least one convex curve surface is required, but it is preferable to arrange two or more convex curve surfaces side by side in the tire axis direction. By forming the support surface 4a of the annular shell 4 so that two or more convex curve surfaces are arranged side by side as described above, the support surface 4a comes into contact with the surface of the tire inner wall at two or more places, and accordingly, local wear caused in the surface of the tire inner wall is reduced. As a result, the distance allowing run-flat driving to be continued can be increased.

The aforementioned annular shell 4 is required to support weight of the vehicle by way of the punctured pneumatic tire 2 and accordingly is made of a rigid material. As the constituent material thereof, it is preferable to use metal such as steel or aluminum. In particular, when the annular shell 4 is made of metal having a yield strength of 400 MPa or more, or preferably, 500 MPa or more, the annular shell is less likely to be plastically deformed at the time of mounting. The upper limit of the yield strength is not particularly limited, but the upper limit thereof is set to 1500 MPa for economic reasons. For example, in the case of molding the annular shell 4 from spring steel, hot-drawing is optimal.

The constituent material of the aforementioned annular shell 4 can be resin or the like. The resin may be either thermoplastic resin or thermosetting resin. Examples of the thermoplastic resin may be nylon, polyester, polyethylene, polypropylene, polystyrene, polyphenylene sulfide, ABS, and the like. Examples of the thermosetting resin may be epoxy resin, unsaturated polyester resin, and the like. The resin may be used independently, and moreover, the resin may be blended with reinforced fibers and used as the fiber reinforced resin.

The elastic rings 5 and 5 are attached to the leg parts 4b and 4b of the annular shell 4 and support the annular shell 4 while abutting on left and right rim seats. These elastic rings 5 and 5 absorb shock and vibration which the annular shell 4 receives from the punctured pneumatic tire 2, and prevent the annular shell 4 from slipping relative to the rim sheets to support stably the annular shell 4.

As the constituent material of the elastic rings 5 and 5, rubber or resin can be used, and rubber is especially preferred. Examples of rubber include natural rubber (NR), isoprene rubber (IR), styrene-butadiene rubber (SBR), butadiene rubber (BR), hydrogenated NBR, hydrogenated SBR, ethylene propylene rubber (EPDM, EPM), butyl rubber (IIR), acrylic rubber (ACM), chloroprene rubber (CR), silicone rubber, fluorocarbon rubber, and the like. Surely, each of these types of rubber can be properly blended with an additive such as a filler, a vulcanizing agent, a vulcanization accelerator, a softener, and an anti-oxidant. Accordingly, it is possible to obtain a desired coefficient of elasticity based on the rubber components to be blended.

In the tire wheel assembly structured as described above, when the pneumatic tire 2 goes flat while the vehicle is running, the flat pneumatic tire 2 is supported by the support surface 4a of the annular shell 4 of the run-flat support 3, thus enabling run-flat driving.

Herein, an interval between abutting points 5a and 5a where the pair of left and right elastic rings 5 and 5 abut on the inner surface of the tire when the pneumatic tire 2 and the run-flat support 3 are mounted on the rim 1 is indicated by W1. On the other hand, as shown in FIG. 2, an interval between the abutting points 5a and 5a of the pair of left and right elastic rings 5 and 5 before the run-flat support 3 is mounted on the rim 1 is indicated by W2. At this time, a relation (W2−W1)/W1=0.015-0.100 is satisfied. Furthermore, W2−W1 is, preferably, equal to 3 to 15 mm.

The interval W2 between the abutting points 5a and 5a of the elastic rings 5 and 5 before the run-flat support 3 is mounted on the rim is set to be larger than the interval W1 between the abutting points 5a and 5a of the elastic rings 5 and 5 when the run-flat support 3 is mounted on the rim at a predetermined ratio as described above. The elastic rings 5 and 5 are thereby firmly seated in a place where the elastic rings 5 and 5 abut on the inner surface of the tire based on its own restoring force at the time of mounting, thus enhancing the durability in run-flat driving. When (W2−W1)/W1<0.015 is satisfied, the fitness of the elastic rings 5 and 5 becomes insufficient, and when (W2−W1)/W1>0.100 is satisfied, the elastic rings 5 and 5 might buckle while being fitted to the rim 1 to degrade the performance of run-flat driving.

Note that in setting the intervals W1 and W2 of the abutting points 5a and 5a of the elastic rings 5 and 5 as described above, the specific structure thereof is not particularly limited. For example, a part of each elastic ring 5 may be projected outward in the direction of the shell axis by inclining or curving the elastic rings 5 and 5 outward in the direction of a shell axis. The elastic rings 5 and 5 may be projected outward in the direction of the shell axis by inclining the leg parts 4b and 4b of the annular shell 4 outward in the direction of the shell axis.

In the aforementioned tire wheel assembly, the JIS-A hardness of the elastic rings 5 and 5 at room temperature (25° C.) is preferably 50 to 65. Specifically, in the case where the interval W2 between the abutting points 5a and 5a of the elastic rings 5 and 5 before mounting is set to be larger, if the elastic rings 5 and 5 are excessively hard, the elastic rings 5 and 5 are compressed and deformed inward in the direction of the shell axis at the time of pushing the pneumatic tire 2 into the rim 1, and the annular shell 4 might be plastically deformed accordingly. However, by setting the JIS-A hardness of the elastic rings 5 and 5 within the aforementioned range, it is possible to prevent the annular shell 4 from being plastically deformed at the time of mounting. Additionally, if the elastic rings 5 and 5 are excessively soft, run-flat driving becomes unstable.

### EXAMPLES

Steel plates with a thickness of 1.0 mm were processed into the annular shells, and the elastic rings made of hard rubber were attached to the leg parts of the annular shells to fabricate the run-flat supports. In tire wheel assemblies each including a pneumatic tire (tire size: 205/55R16 89V) and a wheel (rim size: 16×6 1/2JJ), the fabricated run-flat supports were inserted into cavity sections of the pneumatic tires, thus obtaining the tire wheel assemblies of Examples 1 and 2, Conventional Example, and Comparative Example.

In these Examples 1 and 2, Conventional Example, and Comparative Example, values of (W2−W1)/W1 were varied. Herein, W1 indicates the interval between the abutting points where the pair of left and right elastic rings of the run-flat support abut on the inner surface of the tire when the pneumatic tire and the run-flat support are mounted on the rim, and W2 indicates the interval between the abutting points when the run-flat support is not mounted on the rim.

The above-described four types of the tire wheel assemblies were evaluated by the following measuring method in terms of the durability in run-flat driving, and the results thereof are shown in Table 1.

[Durability in Run-Flat Driving]

The tire wheel assembly to be tested was attached to an front right wheel of an FR (front-engine rear-drive) car of 2.5 liter displacement. Internal pressure of the tire is set to 0 kPa (internal pressure of the tires except for the front right wheel is 200 kPa). The car was driven in a circuit counterclockwise at a speed of 90 km/h. The mileage before running becomes impossible was measured. The evaluation results were indicated by index with the measured mileage of the tire wheel assembly of Conventional Example being defined as 100. Larger index mean more excellent durability in run-flat driving.

TABLE 1

| | Conventional | | | Comparative |
|---|---|---|---|---|
| | Example | Example 1 | Example 2 | Example |
| (W2 − W1)/W1 | 0 | 0.015 | 0.100 | 0.150 |
| Durability in | 100 | 108 | 108 | 100 |
| run-flat | | | | |
| driving | | | | |

As shown in Table 1, the tire wheel assemblies of Examples 1 and 2 were improved in durability in run-flat driving compared to that of Conventional Example. On the other hand, the tire wheel assembly of Comparative Example did not obtain the effect of enhancing the durability.

### INDUSTRIAL APPLICABILITY

According to the present invention, in the tire wheel assembly in which the pneumatic tire is fitted to the rim of the wheel and the run-flat support composed of the annular shell and the pair of left and right elastic rings is inserted in the cavity section of the pneumatic tire, the relation (W2−W2)/W1=0.015-0.100 is configured to be satisfied. Herein, W1 indicates the interval between the abutting points where the pair of left and right elastic rings abut on the inner surface of the tire when the pneumatic tire and the run-flat support are mounted on the rim, and W2 indicates the interval between the abutting points when the run-flat support is not mounted on the rim. The elastic rings can be therefore firmly seated in the places where the elastic rings abut on the inner surface of the tire at the time of mounting, thus enhancing the durability in run-flat driving.

Hereinabove, the preferred embodiment of the present invention was described in detail, and it should be understood that various modifications, replacements, and substitutions thereof can be made without departing from the spirit and the scope of the present invention as defined by the appended claims.

What is claimed is:

1. A tire wheel assembly in which a pneumatic tire is fitted to a rim of a wheel and a run-flat support is inserted in a cavity section of the pneumatic tire, the run-flat support including an annular shell and a pair of left and right elastic rings, the annular shell having a support surface projecting to the outer circumferential side and leg parts extending along both sides of the support surface, and the elastic rings supporting the leg parts of the annular shell on the rim, wherein
a relation (W2−W1)/W1=0.015-0.100 is satisfied assuming that W1 is an interval between abutting points where the pair of left and right elastic rings abut on the inner surface of the tire when the pneumatic tire and the run-flat support are mounted on the rim and W2 is an interval between the abutting points when the run-flat support is not mounted.

2. The tire wheel assembly according to claim 1, wherein a JIS-A hardness of the elastic rings is 50 to 65.

3. The tire wheel assembly according to claim 1, wherein the annular shell is composed of metal with a yield strength of 400 MPa or more.

4. The tire wheel assembly according to claim 2, wherein the annular shell is composed of metal with a yield strength of 400 MPa or more.
